(19) United States
(12) Patent Application Publication
(10) Pub. No.: US 2006/0120544 A1
(43) Pub. Date: Jun. 8, 2006

(54) Capacitor microphone unit and capacitor microphone

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/247,156

(22) Filed: Oct. 12, 2005

(30) Foreign Application Priority Data
Dec. 8, 2004 (JP) 2004-355234

(51) Int. Cl. H04R 25/00; H04R 17/02; H04R 19/04

(52) U.S. Cl. 381/174; 381/369

(57) ABSTRACT

A capacitor microphone unit which includes a diaphragm assembly constituted by a diaphragm and a diaphragm support, a fixed electrode facing with the diaphragm with a clearance and functioning as a capacitor together with the diaphragm, a unit case housing components including the diaphragm assembly and the fixed electrode, and an elastic and conductive shock absorber provided between the diaphragm assembly, the fixed electrode and the unit case.

### CROSS REFERENCE TO RELATED APPLICATIONS

This application is based upon and claims the benefit of priority from prior Japanese Patent Application No. 2004-355,234 filed on or around Dec. 8, 2004; the entire contents of which are incorporated by reference herein.

### BACKGROUND OF THE INVENTION

1. Field of the Invention

This invention relates to a capacitor microphone unit and a capacitor microphone which are designed to prevent vibration noises.

2. Description of the Related Art

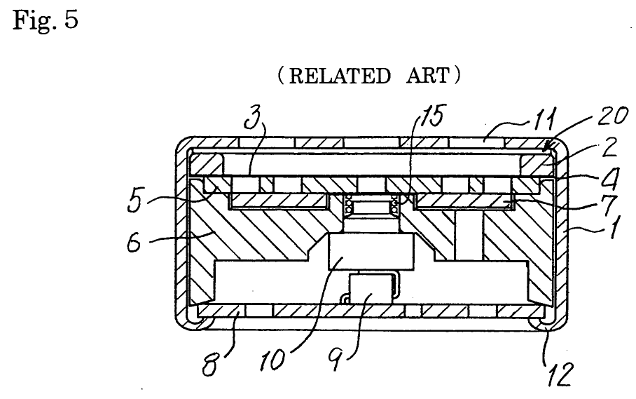

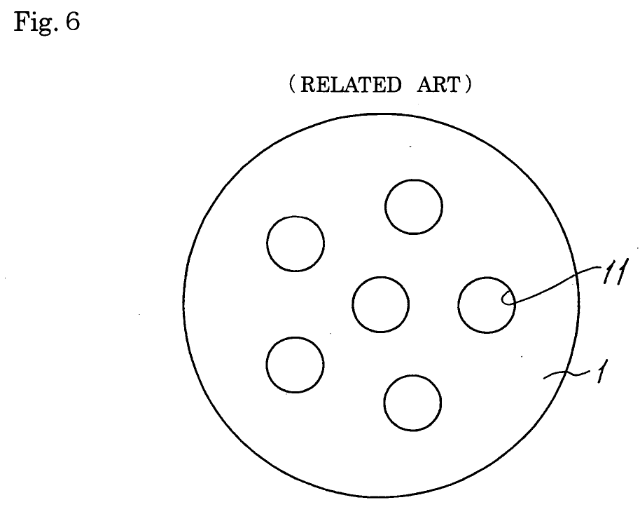

FIG. 5 and FIG. 6 of the accompanying drawings show an example of a capacitor microphone unit of the related art. The capacitor microphone unit includes a cylindrical unit case 1, which has a front mesh 11. The front mesh 11 is positioned at a front part of the microphone unit (the front mesh 11 will be called the “mesh 11” hereinafter). Voice signals are introduced into the microphone unit via the mesh 11. A diaphragm assembly 20 is positioned nearest the mesh 11, and is constituted by an annular diaphragm support 2 and a diaphragm 3 whose peripheral edge is fixed to one end of the diaphragm support 2 using an adhesive.

A fixed electrode 5 faces with the diaphragm 3 via an annular spacer 4, which is made of a thin resin material and is in close contact with a rear peripheral edge of the diaphragm 3. The diaphragm 3 and the fixed electrode 5 define a space which is as thick as the spacer 4. The fixed electrode 5 is a metal disc, which has an electret plate attached on one surface thereof facing with the diaphragm 3, and constitutes an electret board. The diaphragm 3 and the fixed electrode 5 function as a kind of a capacitor. As the diaphragm 3 vibrates in response to sounds introduced via the mesh 11, an electrostatic capacity of the capacitor varies. Variations of the electrostatic capacity are output as voice signals.

A fixed electrode support 6 is disposed behind the fixed electrode 5 in the unit case 1. The fixed electrode 5 is fitted in a first circular recess of the fixed electrode support 6. Further, a second circular recess is present in the first circular recess, and receives an annular damper therein. A circular printed circuit board 8 is in contact with a rear peripheral edge of the fixed electrode support 6. A fold 12 at an open end of the unit case 1 is in contact with the rear peripheral edge of the printed circuit board 8. The printed circuit board 8 is pushed forward (upward in FIG. 5) by the fold 12. Further, the fixed electrode support 6 is pressed, the fixed electrode 5 is pressed via the damper 7, and the diaphragm assembly 20 is pushed toward the mesh 11 of the unit case 1 via the spacer 4. Thus, the foregoing components remain stationary in the unit case 1.

The fixed electrode support 6 has a hole at its center along the thickness thereof. The contact 10 has a gradually varying diameter, and is fitted in the foregoing hole via its small diameter portion. A field effect transistor (FET) 9 is provided on the printed circuit board 8 at a position facing with the contact 10. The FET 9 functions as an impedance transformer. A terminal of the FET9 is soldered to a related circuit pattern of the printed circuit board 8 while the other terminal of the FET9 is folded along the profile of the FET9, and comes into contact with a lower surface of the contact 10. A coiled contact spring 15 in a compressed state is positioned around the upper outer periphery of the contact 10. The coiled contact spring 15 is interposed between the fixed electrode 5 and the contact 10, and separates the fixed electrode 5 and the contact 10. Therefore, the contact 10 is pressed toward one of the terminals on the FET 9, thereby electrically connecting the terminal and the fixed electrode 5.

External vibrations or shocks are applied to the foregoing capacitor microphone, and are transmitted to the components housed in the unit case 1. Thus, the diaphragm 3 and the fixed electrode 5 relatively move in response to vibrations or shocks, which varies the electrostatic capacity. As a result, vibration noises will be produced.

Japanese Patent Laid-Open Publication No. 2000-152,360 describes a capacitor microphone in which a microphone is supported using an antishock holder in order to prevent transmission of vibrations to the microphone and generation of noises.

In Japanese Patent Laid-Open Publication No. Hei 11-331,987, vibrations are detected by a sensor, and signals converted by a microphone unit are attenuated, so that vibration noises will be suppressed.

Further, Japanese Patent Laid-Open Publication No. Hei 11-252,675 describes a microphone in which a microphone unit is attached via an antishock holder at a tip of a microphone grip, thereby suppressing vibration noises.

In the foregoing patent publications, the microphone itself is attached via the antishock holder or the microphone unit is supported via the antishock holder. However, they do not suggest to provide a member preventing vibration noises in the microphone unit. One of the reasons is that it is very difficult to incorporate a shield structure for external electromagnetic waves in the microphone unit together with the vibration noise preventing member. As an example of the shield structure, it is conceivable to provide a metal spring between a unit case and a grounding electrode and to electrically connect them. However, since the unit case and the grounding electrode are in point contact with each other, they may be unstable in their electric connection and have a complicated structure. Up to now, no microphone having such a shield structure is actually available.

When considering a mechanism which generates vibration noises due to a structure of the microphone unit, the unit case and components mounted therein instantaneously move in response to an external force applied thereto while the diaphragm tends to remain stationary, which will change a clearance between the diaphragm and the fixed electrode. Therefore, if the components in the unit case are designed to be movable in parallel to the unit case in response to vibrations or shocks applied to the unit case, which is effective in reducing vibration noises.

### SUMMARY OF THE INVENTION

The invention has been contemplated in order to overcome the foregoing problems of the related art, and is intended to provide not only a capacitor microphone unit which includes a structure reducing vibration noises and is shielded against external forces, but also a capacitor microphone including such a microphone unit.

There is provided a capacitor microphone unit which includes capacitor microphone unit comprising, a diaphragm assembly constituted by a diaphragm and a diaphragm support, a fixed electrode facing with the diaphragm with a clearance and functioning as a capacitor together with the diaphragm, a unit case housing components including the diaphragm assembly and the fixed electrode; and an elastic and conductive shock absorber provided between the diaphragm assembly, the fixed electrode and the unit case.

The elastic and conductive shock absorber protects the internal components against vibrations and shocks, reduce vibration noises, and shields the microphone unit against external electromagnetic waves.

### BRIEF DESCRIPTION OF THE INVENTION

In all Figures, identical parts have identical reference numbers.

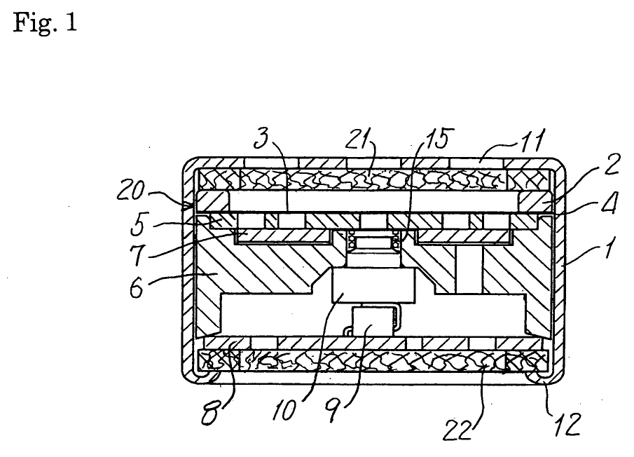

FIG. 1 is a longitudinal cross section of a capacitor microphone unit according to one embodiment of the invention;

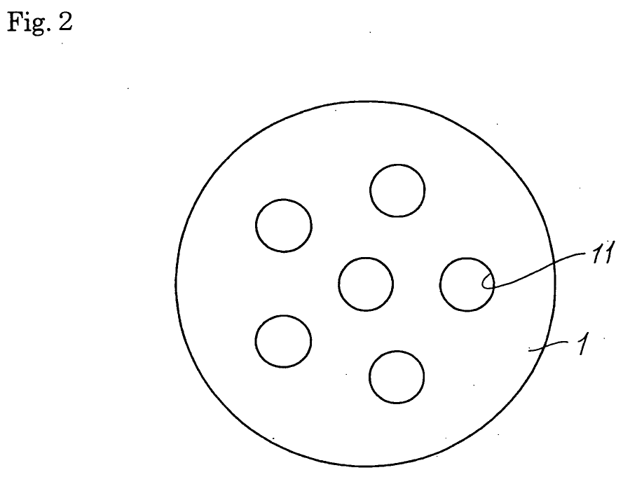

FIG. 2 is a top plan view of the microphone unit;

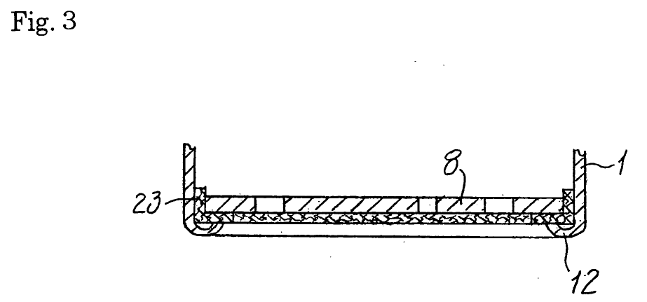

FIG. 3 is a longitudinal cross section showing a main part of a capacitor microphone unit according to a modified example of the embodiment;

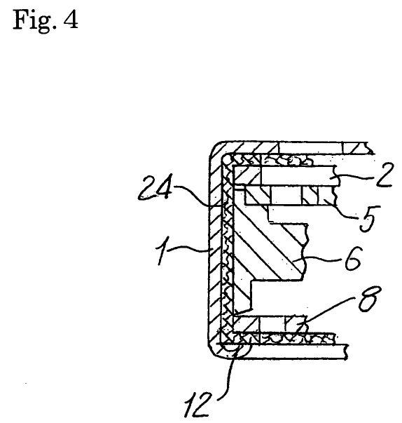

FIG. 4 is a longitudinal cross section showing a microphone unit according to a further modified example of the embodiment;

FIG. 5 is a longitudinal cross section of a capacitor microphone unit of the related art; and

FIG. 6 is top plan view of the capacitor microphone unit of FIG. 5.

### DETAILED DESCRIPTION OF THE INVENTION

The invention will be described with reference to embodiments shown in FIG. 1 to FIG. 4.

Referring to FIG. 1 and FIG. 2, a unit case 1 is cylindrical and has a front mesh 11 (called the “mesh 11”), via which sounds are introduced. The mesh 11 serves as a front part of a capacitor microphone. A shock absorber 21 is housed in the unit case 1 nearest the mesh 11. The shock absorber 21 is made of a conductive material, is annular, and is slightly thinner than the unit case 1, so that the shock absorber 21 does not extend over the mesh 11. The conductive material may be metal threads regularly or irregularly woven in the shape of a fabric. SUI-78-5010T produced by Taiyou Wire Netting Co., may be usable as the shock absorber. Alternatively, the shock absorber may be made of conductive sponges, conductive rubbers, or the like.

In the unit case 1, a diaphragm assembly 20 is placed on the shock absorber 21. The diaphragm assembly 20 includes an annular diaphragm support 2, and a diaphragm 3 whose peripheral edge is attached to one end of the diaphragm support 2 using an adhesive. A fixed electrode 5 faces with the diaphragm 3 via a spacer 4, which is made of a thin annular resin material, and is in close contact with an outer peripheral edges of the diaphragm 3. A clearance is defined between the diaphragm 3 and the fixed electrode 5, and is as thick as the spacer 4. The fixed electrode 5 is constituted by an annular metal, and has an electret plate at one end thereof facing with the diaphragms 3. The diaphragm 3 and the fixed electrode 5 function as a capacitor. A capacitance of the capacitor varies with vibrations of the diaphragm 3 in response to sounds arriving via the mesh 11, so that variations of the capacitance of the capacitor are outputted as voice signals.

A fixed electrode support 6 is positioned behind the fixed electrode 5 in the unit case 1, is made of an insulating material such as a resin, and is cylindrical. The fixed electrode support 6 has a circular recess at its front end, and receives the fixed electrode 5 therein. The fixed electrode support 6 has a further circular recess, in which an annular damper 7 is fitted. A circular printed circuit board 8 is in contact with a rear peripheral edge of the fixed electrode support 6. Another annular shock absorber 22 is placed on the rear peripheral edge of the printed circuit board 8. The shock absorber 22 is shaped similarly to the shock absorber 21. A folded end 12 of the unit case 1 is in contact with the rear peripheral edge of the shock absorber 22, and pushes the printed circuit board 8 forward (upward shown in FIG. 1) via the shock absorber 22. Further, the fixed electrode support 6, damper 7, fixed electrode 5, spacer 4 and diaphragm assembly 20 are pushed one after another. Still further, the shock absorber 21 is pushed toward the bottom of the unit case 1. In this manner, the foregoing components are housed in the unit case 1.

The fixed electrode support 6 has a hole at its center, into which a small diameter part of the contact 10 is fitted. The contact 10 has a diameter varying in a phased manner. A field effect transistor 9 (FET 9 hereinafter) is provided on the circuit board 8 at a position facing with the contact 10, and constitutes an impedance transformer. Further, the fixed electrode support 6 has a recess at a rear end thereof, into which a large diameter part of the contact 10 and the FET 9 are fitted. A first terminal of the FET 9 is connected (is soldered for example) to a predetermined circuit pattern of the printed circuit board 8 while a second terminal of the FET 9 is folded back along the FET 9 and is in contact with the lower surface of the contact 10. A coiled contact spring 15 is positioned on a top of the contact 10 in a compressed state, i.e., the coiled contact spring 15 is between the fixed electrode 5 and the contact 10, thereby separating the fixed electrode 5 and the contact 10. Therefore, the contact 10 is pressed to the second terminal of the FET 9, thereby electrically connecting the second terminal and the fixed electrode 5.

When external vibrations or shocks are applied, they are buffered by the shock absorbers 22 and 21, and are transmitted to the capacitor microphone unit. The components in the unit case 1 move parallel in unison, which maintains the clearance between the diaphragm 3 and the fixed electrode 5. This is effective in suppressing generation of noises. The unit case 1 and the components in the unit case 1, especially the grounding pattern of the circuit board 8, are electrically connected via the conductive shock absorber 22. External electromagnetic waves are blocked by the shock absorber 22, so that noises resulting from electromagnet waves are prevented. The components are in pressure contact with one another in the unit case 1 by the elasticity of the shock absorbers 21 and 22, and are reliably protected against vibrations or shocks.

The components in the unit case 1 can be sufficiently protected against vibrations and shocks even when only the shock absorber 22 is utilized.

A modified example of the capacitor microphone unit will be described hereinafter. The absorbers 22 and 21 shown in FIG. 1 and FIG. 2 are made of flat plates which are in contact with flat parts of the components in the unit case 1. In the modified example, an additional shock absorber 23 shown in FIG. 3 has a flat part and a cylindrical part. The flat part is in contact with the bottom of the circuit board 8 while the cylindrical part is in contact with the peripheral surface of the circuit board 8. This structure further improves buffer effect and shield effect.

In a further modified example shown in FIG. 4, an elastic and conductive shock absorber 24 is cylindrical, and is in contact with front and rear surfaces of the components in the unit case 1. In other words, the shock absorber 24 is shaped as if the shock absorbers 22 and 21 shown in FIG. 1 and FIG. 2 are coupled via a cylindrical member, or as if the opposite ends of the cylindrical member are in the shape of an inward flange. The shock absorber 24 encloses the components in the unit case 1, which improves the buffer effect and shield effect.

In the foregoing examples, the components are assembled in the microphone case, which is effective in reducing vibration noises and noises caused by electromagnetic waves. Further, vibration noises and noises caused by electromagnetic waves can be reduced without supporting the microphone unit or the microphone itself via the shock absorbers. The microphone can be protected against noises using a simple structure.

What is claimed is:

1. A capacitor microphone unit comprising: a diaphragm assembly constituted by a diaphragm and a diaphragm support; a fixed electrode facing with the diaphragm with a clearance and functioning as a capacitor together with the diaphragm; a unit case housing components including the diaphragm assembly and the fixed electrode; and an elastic and conductive shock absorber provided between the diaphragm assembly, the fixed electrode and the unit case.

2. The capacitor microphone unit of claim 1, wherein the shock absorber is in the shape of an elastic fiber made of woven metal threads.

3. The capacitor microphone unit of claim 1, wherein the unit case is cylindrical, and has a bottom and a folded open end; the components are positioned by the folded end of the unit case; and the shock absorber is present between the folded end of the unit case and the components.

4. The capacitor microphone unit of claim 1, wherein the diaphragm assembly, the fixed electrode, the fixed electrode support, a circuit board and the shock absorber are arranged in the unit case in sequence, and are positioned in a pressed state by a folded open end of the unit case.

5. The capacitor microphone unit of claim 3 or 4, wherein an additional shock absorber is provided between the bottom of the unit case and the components housed in the unit case.

6. The capacitor microphone unit of claim 1, wherein the shock absorber includes a flat part in contact with axial end faces of the components and a cylindrical part extending between outer surfaces of the components and an inner surface of the unit case.

7. The capacitor microphone unit of claim 1, wherein the shock absorber includes a flat part in contact with axial end faces of the components, a cylindrical part extending between outer surfaces of the components and an inner surface of the unit case, a part extending between the folded open end the unit case and the components, and a part extending between the bottom of the unit case and the components.

8. A capacitor microphone comprising a capacitor microphone unit which is defined in any one of claims 1 to 7, and is housed in a microphone case.
